(19) United States
(12) Patent Application Publication
(10) Pub. No.: US 2013/0318308 A1
(43) Pub. Date: Nov. 28, 2013

(54) SCALABLE CACHE COHERENCE FOR A NETWORK ON A CHIP

(71) Applicant: Sonics, Inc., Milpitas, CA (US)

(72) Inventors: Doddaballapur N. Jayasimha, Sunnyvale, CA (US); Drew E. Wingard, Palo Alto, CA (US)

(73) Assignee: Sonics, Inc., Milpitas, CA (US)

(21) Appl. No.: 13/899,258

(22) Filed: May 21, 2013

Related U.S. Application Data
(60) Provisional application No. 61/651,202, filed on May 24, 2012.

(51) Int. Cl. G06F 12/08

(52) U.S. Cl. CPC G06F 12/0833
USPC 711/146; 711/141

(57) ABSTRACT

Maintaining cache coherence in a System-on-a-Chip with both multiple cache coherent master IP cores (CCMs) and non-cache coherent master IP cores (NCMs). A plug-in cache coherence manager (CM), coherence logic in agents, and an interconnect are used for the SoC to provide a scalable cache coherence scheme that scales to an amount of CCMs in the SoC. The CCMs each includes at least one processor operatively coupled through the CM to at least one cache that stores data for that CCM. The CM maintains cache coherence responsive to a cache miss of a cache line on a first cache of the caches, then broadcasts a request for an instance of the data stored corresponding to cache miss of the cache line in the first cache. Each CCM maintains its own coherent cache and each NCM is configured to issue communication transactions into both coherent and non-coherent address spaces.

### RELATED APPLICATIONS

This application claims priority to and the benefit of Provisional Patent Application No. 61/651,202, titled, “Scalable Cache Coherence for a Network on a Chip,” filed May 24, 2012 under 35 U.S.C. §119.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### FIELD

In general, one or more embodiments of the invention related to cache coherent systems. In an embodiment, the cache coherent system is implemented in an Integrated Circuit.

### BACKGROUND

In computing, cache coherence (also cache coherency) generally refers to the consistency of data stored in local caches of a shared resource. In a shared memory target IP core multiprocessor system with a separate cache memory for each processor, it is possible to have many copies of any one instruction operand: one copy in the main memory target IP core and one in each cache memory. When one copy of an operand is changed, the other copies of the operand must be changed also. Cache coherence is the scheme that ensures that changes in the values of shared operands are propagated throughout the system in a timely fashion. Coherence may define the behavior of reads and writes to the same memory location. The two most common types of coherence that are typically studied are Snooping and Directory-based, each having its own benefits and drawbacks.

### SUMMARY

Various methods and apparatuses are described for a cache coherence system. In an embodiment, a System on a Chip may include at least a plug-in cache coherence manager, coherence logic in one or more agents, one or more non-cache-coherent masters, two or more cache-coherent masters, and an interconnect. The plug-in cache coherence manager, coherence logic in one or more agents, and the interconnect for a System on a Chip are configured to provide a scalable cache coherence scheme for the System on a Chip that scales to an amount of cache coherent master intellectual property cores in the System on a Chip. The plug-in cache coherence manager and coherence logic maintain consistency of memory data potentially stored in one or more local memory caches including a first local memory cache for a first cache coherent master intellectual property core and a second local memory cache for a second cache-coherent master intellectual property core. Two or more master intellectual property cores including the first and second intellectual property cores are configured to send read or write communication transactions (such as request and response packet formatted communication and request and response non-packet formatted communications) over the interconnect to an IP target memory core. One or more additional intellectual property cores in the System on a Chip are either an un-cached master or a non-cache-coherent master, which are also configured send read and/or write communication transactions over the interconnect to the IP target memory core.

### BRIEF DESCRIPTION OF THE DRAWINGS

The multiple drawings refer to the embodiments of the invention.

FIG. 1 illustrates a block diagram of an embodiment of a snoop-based cache coherence manager to provide a scalable cache coherence scheme for the System on a Chip that scales to an amount of cache coherent master intellectual property cores in the System on a Chip.

FIG. 2 illustrates a block diagram of an embodiment of a centrally located snoop-filter-based cache coherence manager.

FIG. 3 illustrates a block diagram of an embodiment of a directory-based cache coherence manager physically distributed with an instance located by each memory controller in the system.

FIG. 4 illustrates a diagram of an embodiment of a plug-in cache coherence manager implementing a 4-hop protocol for a system with three cache coherent masters.

FIG. 5 illustrates a diagram of an embodiment of a snoop filter based cache coherence manager implementing a 3-hop protocol with a snoop filter table look up.

FIG. 6 illustrates a diagram of an embodiment of an Organization of a Snoop Filter based cache coherent manager.

FIGS. 7A and 7B illustrate tables with an example internal transaction flow for an embodiment of the standard interface to support either a directory-based cache coherence manager, a snoop-based cache coherence manager, and a snoop-filter-based cache coherence manager.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific routines, named components, connections, types of servers, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

Multiple example processes of and apparatuses to provide scalable cache coherence for a network on a chip are described. Various methods and apparatus associated with routing information from master/initiator cores (ICs) to slave target cores (TCs) through one or more routers in a System on a Chip (SoC) interconnect that takes into consideration the disparate nature and configurability of the master/initiator cores and slave target cores are disclosed. The methods and apparatus enable efficient transmission of information through the Network on a Chip/interconnect. The following drawings and text describe various example implementations of the design.

The scalable cache coherence for a network on a chip may support full coherence. The scalable cache coherence provides advantages including a plug in set of logic for a directory based, or snoop based, or snoop filter based coherence manager, where:
1. The snoop based (limited scalable) architecture comfortably goes beyond the number of agents supported previously;
2. The snoop-filter based architecture seamlessly extends the snoop (limited scale) architecture for higher scalability (8-16 or more number of coherent masters); and
3. A partitioning strategy allows other Intellectual Property blocks to be mixed and match with both the coherent and non-coherent IP blocks.

In general, a plug-in cache coherence manager, coherence logic in one or more agents, and an interconnect cooperate to maintain cache coherence in a System-on-a-Chip with both multiple cache coherent master IP cores (CCMs) and un-cached coherent master IP cores (UCMs). The plug-in cache coherence manager (CM), coherence logic in agents, and an interconnect are used for the System-on-a-Chip to provide a scalable cache coherence scheme that scales to an amount of cache coherent master IP cores in the System-on-a-Chip. The cache coherent master IP cores each includes at least one processor operatively coupled through the cache coherence manager to at least one cache that stores data for that cache coherent master IP core. The cache coherence manager maintains cache coherence responsive to a cache miss of a cache line on a first cache of the caches, then broadcasts a request for an instance of the data stored corresponding to cache miss of the cache line in the first cache. Each cache coherent master IP core maintains its own coherent cache and each un-cached coherent master IP core is configured to issue communication transactions into both coherent and non-coherent address spaces.

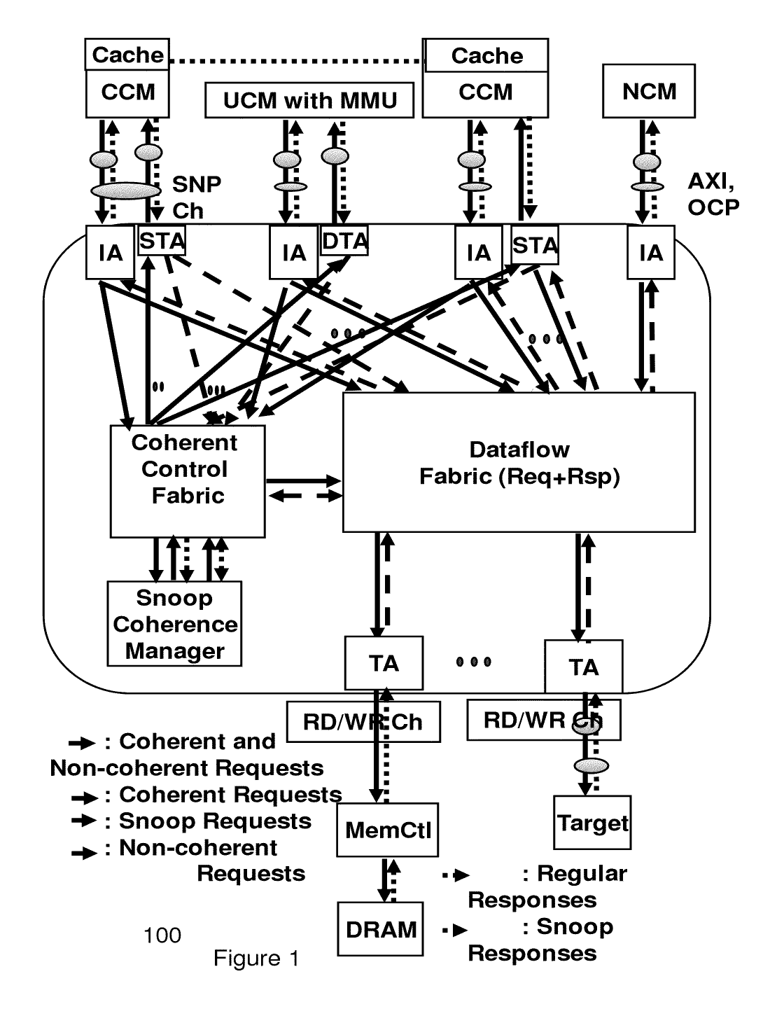

FIG. 1 illustrates a block diagram of an embodiment of a snoop-based cache coherence manager to provide a scalable cache coherence scheme for the System on a Chip that scales to an amount of cache coherent master intellectual property cores in the System on a Chip. The System on a Chip 100 may include a plug-in cache coherence manager (CM), an interconnect, Cache Coherent Master intellectual property cores (CCM), Un-cached Coherent Master intellectual property cores (UCM), Non-coherent Master intellectual property cores (NCM), Master Agents (IA), Target Agents (TA), Snoop Agents (STA), DVM Target Agent (DTA), Memory Management Units (MMU), Target IP cores including a Memory Target IP core and its memory controller.

The plug-in cache coherence manager, coherence logic in one or more agents, and the interconnect for the System on a Chip 100 provide a scalable cache coherence scheme for the System on a Chip 100 that scales to an amount of cache coherent master intellectual property cores in the System on a Chip 100. The plug-in cache coherence manager and coherence logic maintain consistency of memory data potentially stored in one or more local memory caches including a first local memory cache for a first cache coherent master intellectual property core and a second local memory cache for a second cache-coherent master intellectual property core. The master intellectual property cores including the first and second cache-coherent master intellectual property cores, uncached master IP cores, and non-cache-coherent master IP cores are configured to send read or write communication transactions over the interconnect to an IP target memory core. Note, many master cores of any type may connect to the interconnect and the plug-in cache coherent manager but the amount shown in the figure is merely for example purposes.

The plug-in cache coherent manager maintains the consistency of instances of instructional operands stored in the memory IP target core and each local cache of the memory. When one copy of the operand is changed, then the other instances of that operand must also be changed to ensure the value of the shared operands are propagated throughout the integrated circuit in a timely fashion.

The cache coherence manager is the component for the interconnect, which maintains coherence among cache coherent masters, un-cached coherent masters, and the main memory target IP core of the integrated circuit. Thus, the plug-in cache coherent manager maintains the cache coherence in the System on a Chip 100 with multiple cache coherent master IP cores, un-cached-coherent Master intellectual property cores, and non-cache coherent master IP cores.

The master IP cores communicate over the common interconnect. Each cache coherent master includes at least one processor operatively coupled through the plug-in cache coherence manager to at least one cache that stores data for that cache coherent master IP core. The data from the cache is also stored permanently in a main memory target IP core. The main memory target IP core is shared among the multiple master IP cores. The plug-in cache coherence manager maintains cache coherence responsive to a cache miss of a cache line on a first one of the caches, then broadcasts a request for an instance of the data stored corresponding to cache miss of the cache line in the first cache. Each cache coherent master maintains its own coherent cache. Each un-cached coherent master is configured to issue communication transactions into both coherent and non-coherent address spaces.

Note, in the snooping versions of the cache coherence manager, the cache coherence manager broadcasts to the other cache controllers the request for the instance of the data corresponding to the cache miss. Next, responsive to receiving the broadcast request, the cache coherence manager determines whether at least one of the other caches has a correct instance copy of the cache line in the same cache line state, and causes a transmission of the correct copy of the cache line to the cache that missed. Next, the cache coherence manager updates each cache of the current state of the data being stored in the cache line for each node.

The interconnect is composed of 1) a data flow bus fabric separate from 2) its coherence command and signaling fabric that couples to a flexible implementation of a cache coherence manager.

The scalable cache coherence scheme includes the plug-in cache coherence manager implemented as a 1) a snooping-based cache coherence mechanism, 2) a snoop-filtering-based cache coherence mechanism or 3) a distributed directory-based cache coherence mechanism, all of which plug in with their hardware components to support one of the three system coherence schemes above. Thus, a logic block for the cache coherence manager can plug in a variety of hardware components in the logic block to support one of the three system coherence schemes above without changing the interconnect and the coherence logic in the agents.

The plug in nature of the flexible implementation of the cache manager allows scalability via both snooping based coherence logic mechanism with a limited number of coherent masters such as 4 or less and high scalability with a distributed directory based coherence mechanism for a large number of master IP cores operatively coupled through a cache controller to at least one cache (known as a cache coherent master) (8+).

The plug-in cache coherence manager supports any of the three system coherence schemes via a standard interface at a boundary between the coherence command and signaling fabric and the logic block of the cache coherence manager. The user of the system is allowed to choose one of the three different plug-in coherence managers that fits their planned System on a Chip 100 the best. The standard interface allows different forms of logic to be plugged into the logic block of the cache coherence manager to enable supporting this variety of system coherence schemes. The standard interface of control signals exist between the boundary between the coherence manager and the coherence command and signaling fabric.

FIG. 1 graphically shows the plug-in cache coherence manager implemented as a snoop-based cache coherence manager that cooperates with the coherence logic to broadcast a cache access of each local memory cache to all other local memory caches, and vice versa, for the cache coherent master IP cores in the System on a Chip 100. The snoop-based cache coherence manager relies on a snoop broadcast scheme for snooping, and supports communication transactions from both 1) the cache coherent master IP cores and un-cached coherent master IP cores. The master agent and target agent primarily handle communication transactions for any non-cache coherent master IP cores. Snooping may be the process where the individual caches monitor address lines for accesses to memory locations that they have cached and report back to the coherence manager in response to a snoop. The snooping-based cache coherence manager is configured to handle small scale systems such as ones that have 1-4 CCMs and multiple UCMs snoops broadcast to/collected are from all CCMs. The snooping-based cache coherence manager snoops broadcast to all CCMs. Snooped responses and possibly data are sent back to snooping-based cache coherence manager from all the CCMs. The snooping-based cache coherence manager updates the memory IP target core if necessary and keeps track of response from the memory IP target core for ordering purposes.

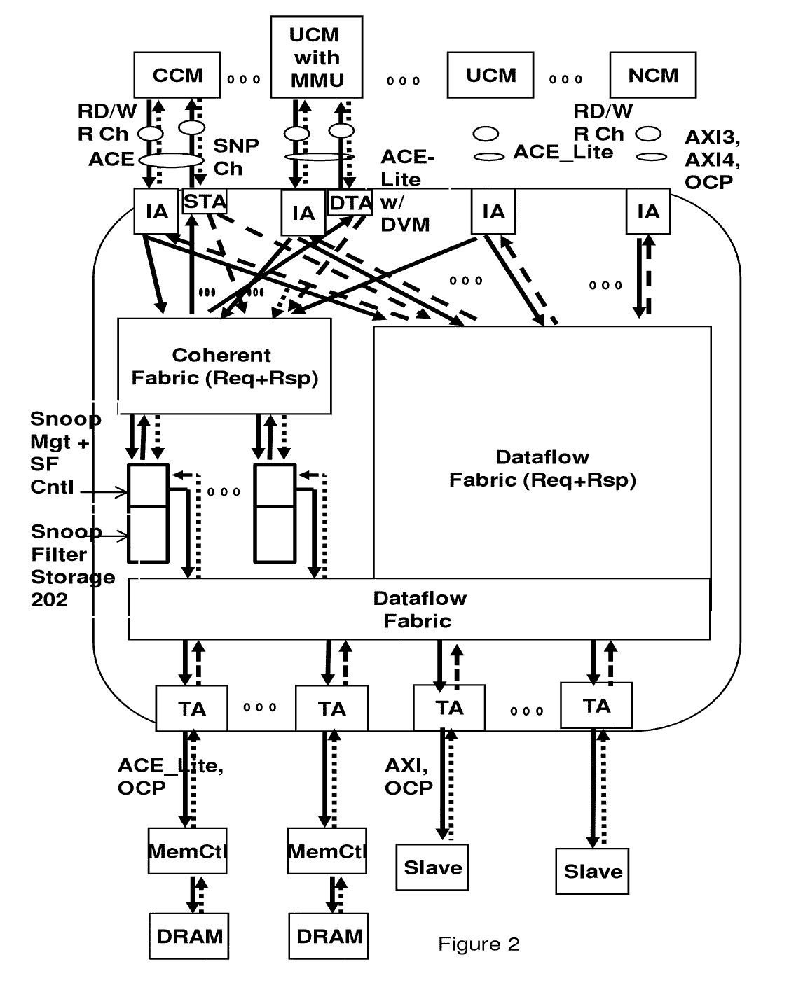

FIG. 2 illustrates a block diagram of an embodiment of a centrally located snoop-filter-based cache coherence manager. The plug-in cache coherence manager may be implemented as a single snoop filter-based cache coherence manager that cooperates with the coherence logic to manager individual caches for access to memory locations that they have cached. The snoop-filter based cache coherence manager 202 may have a management logic portion to control snoop operations, control logic for other operations and a storage section to maintain data on the coherence of the tracked cache lines. The snoop-filter based cache coherence manager 202 individual caches monitor their own address lines for access to memory locations that they have cached via a write invalidate protocol. The snoop-filter based scheme may also rely on the underlying snoop broadcast scheme for snooping along with using a look up scheme. The cache coherence master IP cores communicate through the coherence command and signaling fabric with the single snoop filter-based cache coherence manager 202.

The snoop filter-based cache coherence manager 202 performs a table look up on the plurality of entries to determine a status of cache line entries in all of the local cache memories as well as periodic snooping to check on a state on cache coherent data in each local cache. The snoop-filter reduces the snooping traffic by maintaining a plurality of entries, each entry representing a cache line that may be owned by one or more nodes. When replacement of one of the entries is required, the snoop-filter selects for replacement the entry representing the cache line or lines owned by the fewest nodes, as determined from a presence vector in each of the entries.

In SoC architectures that are sensitive to storage costs and where DRAM designs are standard, the Snoop Filter directory entries are cached. There are primarily two organizations for the caching of the tag information and the presence vectors. The snoop-filter based cache coherence manager 202 may combine aspects of a memory based filter and a cache based filter architecture.

Memory Based Filter: Also known as a directory cache. Any line that is cached has at most one entry in the filter irrespective of how many cache coherence master IP cores this line is cached in.

Cache Based Filter: Also known as distributed snoop filter scheme. A snoop filter which is a directory of CCMs' cache lines in their highest level (L2) caches. A line that is cached has at most one entry in the filter for each identified set of cache coherence master IP cores. Thus, a line may have more than one entry across the whole set of cache coherence master IP cores.

In SoC architectures of interest where cache coherence master IP cores communicate through the coherence fabric with a single logical Coherence Manager 202, the memory based filter and cache based filter architectures collapse into the snoop-filter based architecture.

The main advantage of the directory cache based organization is its relative simplicity (the directory cache is associated with the coherence logic in the agents). The snoop filter based cache coherence manager 202 may be implemented as a centralized directory that snoops but does not perform traditional broadcast and instead, maintains a copy of all highest level cache (HLC)* tags of each cache coherent master in a “snoop filter structure.” Each tag in snoop filter is associated with approximate (but safe) state of corresponding HLC line in each cache coherent master. A single directory that talks to each memory controller. The main disadvantage is that accessing non-local directory caches takes several cycles of latency. This disadvantage is overcome with cache based filter at the expense of space and some complexity in the replacement policy. A distributed directory, with an instance associated with the memory it controls. Directory based design which is physically distributed—associated with each memory controller in system. The directory stores presence vector for each memory block (of cache line size) it is “home” to. Based on distributed directory, where a directory instance is associated with each memory IP target core.

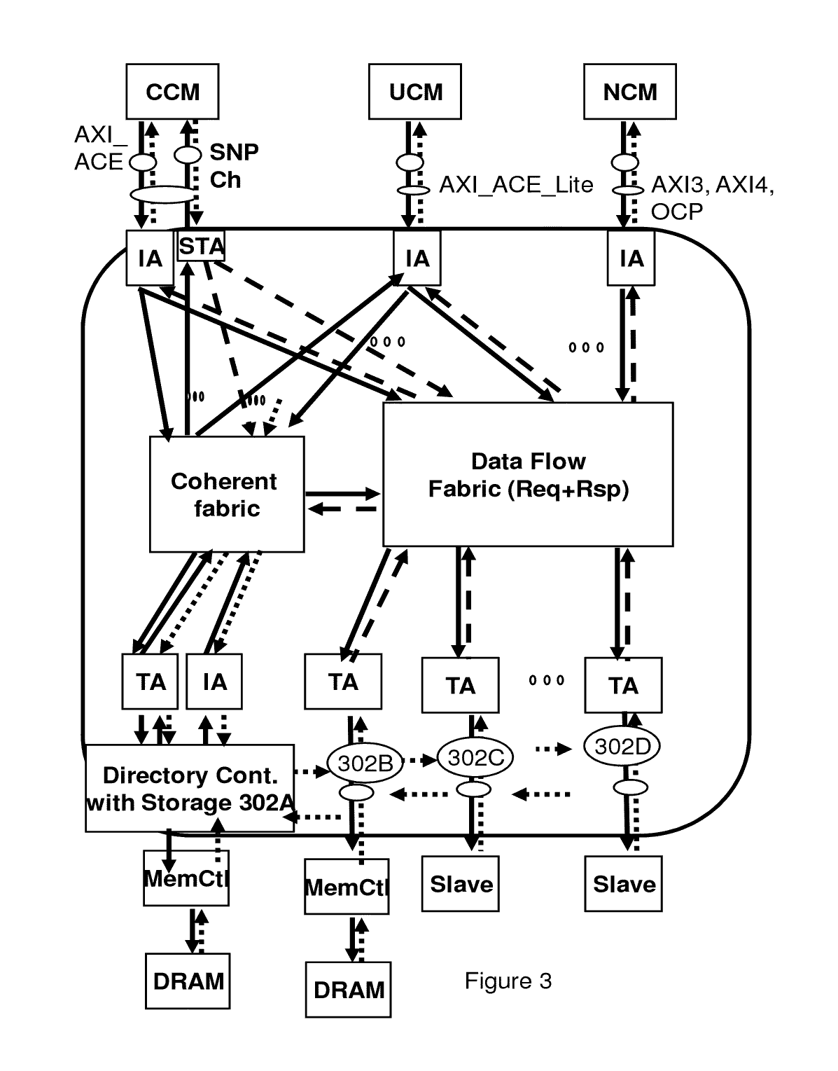

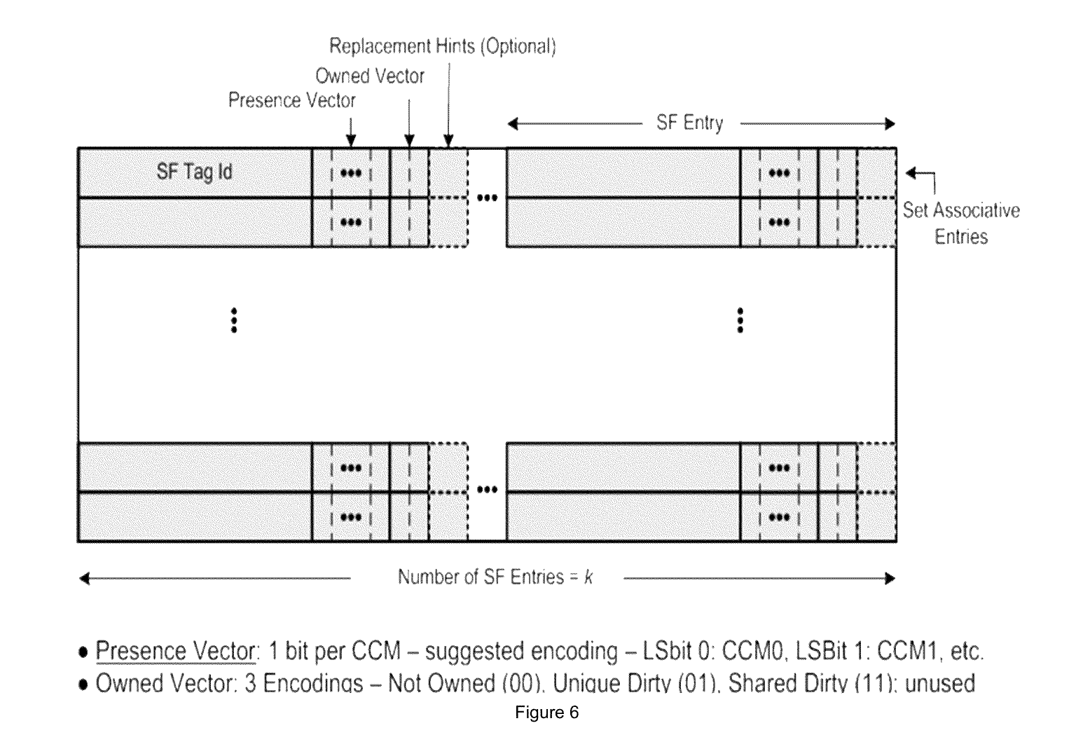

See FIG. 6, for specific implementation of an embodiment of a snoop filter based cache coherence manager. FIG. 2 shows an example plug-in cache coherence manager with a central directory implementation whereas FIG. 3 shows an example plug-in cache coherence manager with a set of distributed directories.

FIG. 3 illustrates a block diagram of an embodiment of a directory-based cache coherence manager physically distributed with an instance located by each memory controller in the system. The plug-in cache coherence manager may be implemented as a directory-based cache coherence manager that keeps track of data being shared in common directory that maintains coherence between at least the first and second local memory caches. The directory based cache coherence manager may be a centrally located directory to improve latency or a set of distributed directories, such as a first distributed instance of a directory-based cache coherence manager 302A through a fourth distributed instance of a directory-based cache coherence manager 302D, cooperating via the coherence command and signaling fabric reduce system choke points. The directory performs a table look up to check on the state on cache coherent data in each local cache. Each local cache knows, via the coherence logic in that cache coherence master's snoop agent, to send a communication to the coherent manager when a change of state occurs to the cache data stored in that cache. The traditional directory architecture, with one directory entry for each cache line, is very expensive in terms of storage needs. However, it is generally more appropriate with distributed memory designs.

The directory-based cache coherence manager, like the snoop filter based cache coherence manager, may be distributed across the network where two or more distributed instances of the cache coherence manager 302A-302D that communicate with each other via a coherence command and signaling fabric (as shown in FIG. 3). Each of the instances of the distributed directory-based cache coherence manager 302A-302D communicate changes in local caches tracked by that instance distributed directory-based cache coherence manager to the other instances.

In the directory-based system, the data being shared is placed in a common directory that maintains the coherence between caches. The directory acts as a filter through which the processor must ask permission to load an entry from the primary memory target IP core to its cache. When an entry is changed in the common directory, the directory either updates or invalidates the other local memory caches with that entry. The directory performs a table look up to check on the state on cache coherent data in each local cache.

In an embodiment, the single directory talks to each memory controller. The main disadvantage compared to a distributed directory is that accessing non-local directory caches takes many cycles of latency. This disadvantage is overcome with cache based filter at the expense of space and some complexity in the replacement policy. A distributed directory has an instance of the cache manager associated with the memory it controls. The directory based design is physically distributed with an instance located by each memory controller in the system. The Directory stores a presence vector for each memory block (of cache line size) it is “home” to.

Overall, the types of coherence, Snooping and Directory-based, each have its own benefits and drawbacks and configuration logic present to the user the option to plug in one of the three types of cache coherent managers. Snooping protocols tend to be faster, if enough bandwidth is available, since all transactions are a request/response seen by all processors. The drawback is that snooping isn't very scalable past 4 cache coherent master IP cores. Every request must be broadcast to all nodes in a system, meaning that as the system gets larger, the size of the (logical or physical) bus and the bandwidth it provides must grow. Directories, on the other hand, tend to have longer latencies (with a 3 hop or 4 hop request/forward/respond protocol) but use much less bandwidth since messages are point to point and not broadcast. For this reason, many of the larger systems (>64 independent processors/independent masters) use this type of directory based cache coherence manager.

Next, the plug-in cache coherence manager has hop logic to implement either a 3-hop or a 4-hop protocol. The cache coherence manager has also has ordering logic to configured to order cache accesses between the two or more masters IP cores in the System on a Chip. The plug-in cache coherence manager may have logic configured 1) to handle all coherence of cache data requests from the cache coherent masters and un-cache coherent masters, 2) to order cache accesses between the two or more masters IP cores in the System on a Chip, 3) to resolve conflicts between the two or more masters IP cores in the System on a Chip, 4) to generate snoop broadcasts and/or perform a table lookup, and 5) to support for speculative memory accesses.

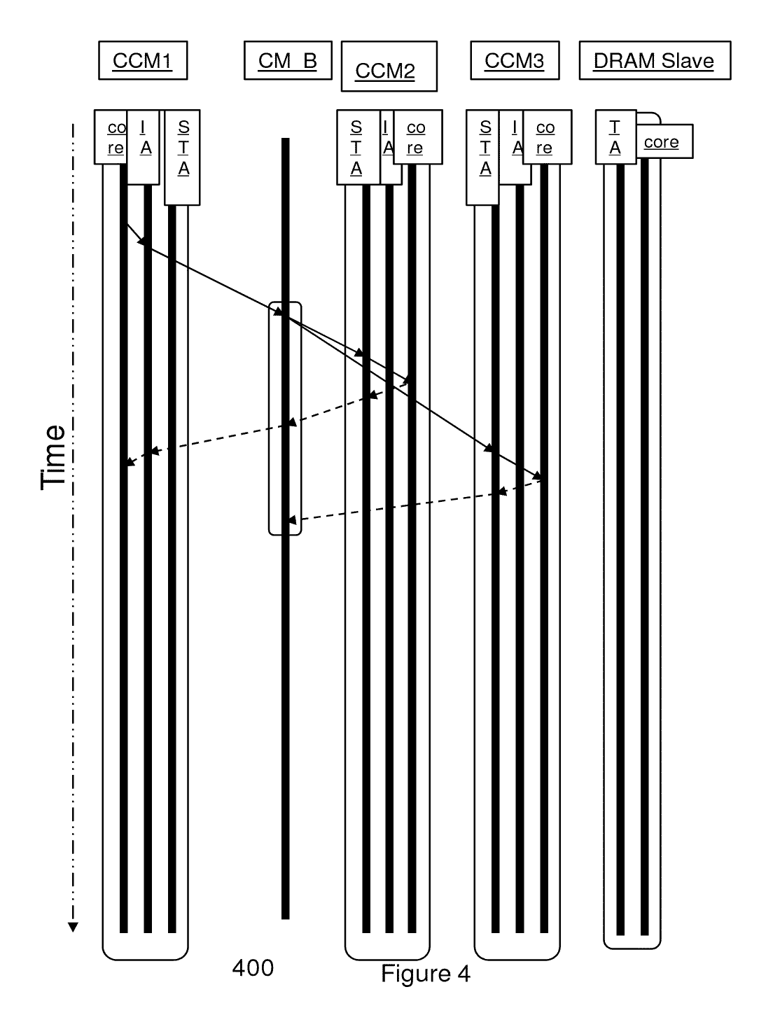

FIG. 4 illustrates a diagram of a plug-in cache coherence manager implementing a 4-hop protocol for a system with three cache coherent masters. The example system three cache coherent master IP cores, CCM1 to CCM3, an example instance of the plug in snoop broadcast based cache coherent manager, CM_B, a target memory IP core (Slave DRAM), and coherence logic in the master agents (IA) and snoop agents (STA). Two example types may be implemented by a cache coherence manager—a 3 hop and a 4 hop protocol. FIG. 4 shows the transaction flow diagram 400 with transaction communications between the components for a 4-hop protocol on X-axis and time on Y-axis (time flows from top to bottom). Each arrow represents a transaction and has an id. Example Requests/Responses transaction communications are indicated by solid arrows for a request and broken arrows for a response. In the 4-hop protocol, a snooped cache line state is first sent to the cache coherent manager and then the coherent manager is responsible for arranging a sending of data to a requesting cache coherent master IP core. Thus, the 4 hop protocol has a cache line transfer to the requester cache coherent master/initiator IP core. With 4-hop protocol, a cache line transfer to the cache coherent master/initiator IP core takes up to 4 protocol steps. In step 1 of the 4-hop protocol, the cache coherent master/initiator's request is sent to cache coherent manager (CM). In step 2, the coherent manager snoops other cache coherent master/initiators. In step 3, the responses from other cache coherent master/initiators, with one or more of them possibly providing the latest copy of the cache line to the coherent manager. In step 4, a transfer of data from the coherent manager to requesting cache coherent master/initiator IP core occurs with a possible writeback to memory target IP core.

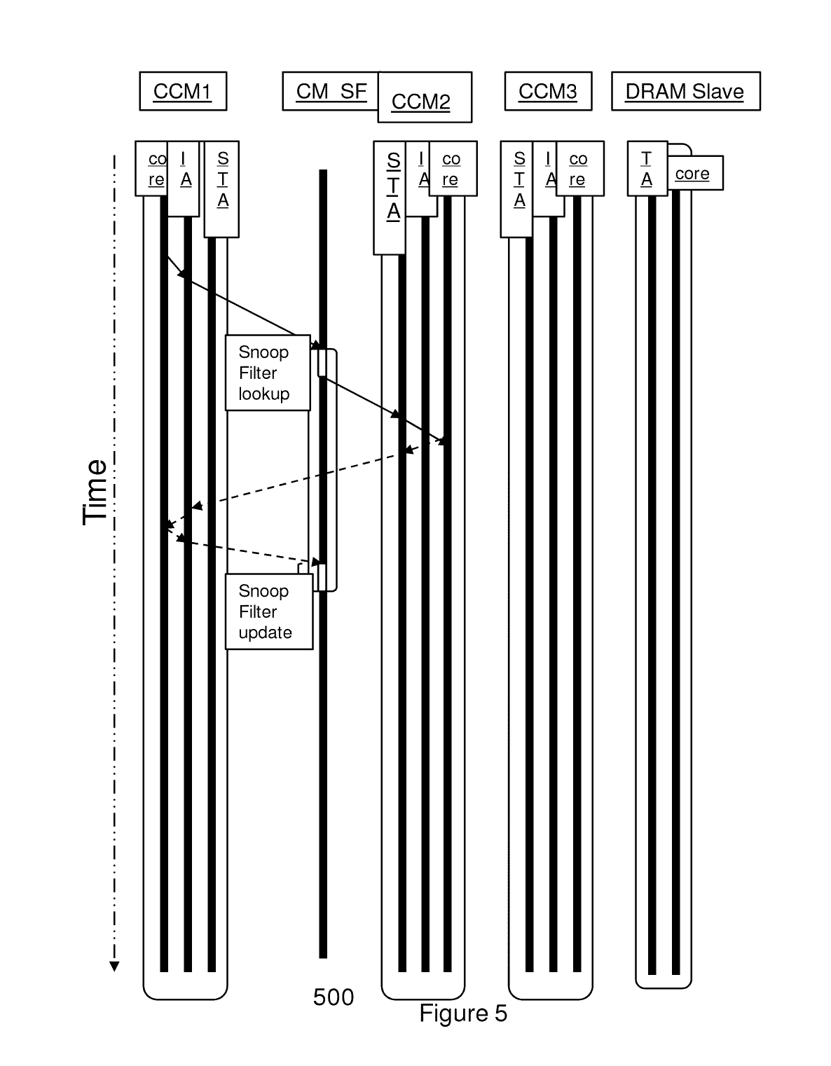

FIG. 5 illustrates a diagram of a snoop filter based cache coherence manager implementing a 3-hop protocol with a snoop filter table look up. The example system three cache coherent master IP cores, CCM1 to CCM3, an example instance of the plug in snoop-filter based cache coherent manager, CM_SF, a target memory IP core (Slave DRAM), and coherence logic in the master agents (IA) and snoop agents (STA). The cache coherent manager and coherence logic in the agents support direct “cache-to-cache” transfers with a 3-hop protocol. With the 3-hop protocol, a cache line transfers to cache coherent master/initiator IP core takes up to 3 protocol steps. In step 1 of the 3-hop protocol in the diagram 500, the cache coherent master/initiator's request is sent to coherent manager (CM). In step 2, the coherent manager snoops the caches of other cache coherent master/initiators IP cores. In step 3, the responses from cache coherent master/initiators is sent to coherent manager and, after a simple handshake, data from the responding cache coherent master/initiator is sent directly to requesting cache coherent master/initiator, with possible writeback to memory.

Overall, the 3-hop protocol has lower latency for data return and lower power consumption while the 4-hop protocol has a simpler transaction flow (a responding cache coherence master IP core sends all responses only to the coherence manager; it doesn't have to send data back to the original requester nor does it have to possibly writeback to memory) and possibly fewer race conditions and therefore lower verification costs. From the perspectives of reducing latency and reducing power, the 3-hop protocol is preferable. The user may choose which version of the hop protocol is implemented with the plug in cache coherence manager.

In an embodiment, the cache coherence manager has logic configured to handle all coherence of cache data requests. An overall transaction flow is presented below.

1. When either 1) a coherent read request (arising typically from a load) or 2) a coherent invalidating request (arising typically from a store) is presented by a cache coherence master IP core at a Master Agent.

2. The Master Agent decodes this request and routes it through the coherent fabric to the coherence manager.

3. The coherence manager (snoop broadcast based and the snoop-filter based) broadcasts snoop requests to the relevant cache coherence masters using the coherence fabric. The “relevant” cache coherence masters are determined based on the shareability domain specified in the transaction. Alternatively, the directory-based coherence manager performs a look up on cache state.

4. The snoop requests are actually targeted to the Snoop Agent (STA) which interfaces with the cache coherence master IP core. The Snoop Agent does some bookkeeping and forwards the request to the cache coherence master IP core.

5. The Snoop Agent receives the snoop response from the cache coherence master IP core possibly with data. It first sends the snoop response without data to the Coherence Manager through the coherence fabric.

6. The Coherence Manager, in turn, requests the first Snoop Agent that has snooped data, to forward the data to the original requester using the coherence fabric. Concurrently, it processes snoop responses from other Snoop Agents—the Coherence Manager either informs these Snoop Agents to consider the transaction complete and possibly drop any snooped data—it again uses the coherence fabric for these requests.

7. A. The chosen Snoop Agent sends the data to the original requester using the system fabric.

7. B. If none of the cache coherence master IP cores respond with data, then the Coherence Manager begins a memory request using the non-coherence fabric (the coherence fabric can also be extended to perform this function, especially, for high performance solutions).

8. The requesting Master Agent (which gets its data either in Step 7A or Step 7B) sends the response to the cache coherence master IP core.

9. The cache coherence master IP core responds with a R_Acknowledge transaction—this is received by the Master Agent and is carried by the coherence fabric to the Coherence Manager. The transaction is now complete from the Master Agent's perspective (it does bookkeeping operations, including deallocation from the crossover queue).

10. The transaction is complete from the Coherence Manager's perspective only when it receives the R_Acknowledge transaction and it has received all the snoop responses—at this time, it does bookkeeping operations, including deallocation from its crossover queue).

The above flow is for illustrative purposes and gives a broad idea about the various components in the coherence architecture. There are many variants that arise from different transactions (e.g., a writeback transaction), whether speculative memory accesses are performed to improve the transaction latency in the case when none of the cache coherence master IP cores returns snooped data, etc. In an embodiment, the master agents have coherence logic configured to 1) route coherent commands and signaling traffic to the coherent commands and signaling fabric, and 2) route all data transactions through the dataflow fabric.

As discussed briefly above, a cache coherence manager has logic to implement a variety of functions. The coherence manager has logic structures for handling: transaction allocation/deallocation, ordering, conflicts, snoop, DVM broadcast/responses, and speculative memory requests.

Overall, functionality of the logic in the cache coherence manager performs one or more of the following. The cache coherence manager handles all coherence of cache data requests, including “cache maintenance” transactions in AXI4_ACE. The cache coherence manager performs snoop generation (sequential or broadcast—broadcast as unicast or multicast), collection. No source snooping from Master Agents to keep design simple for small designs and for large designs of greater than 4 cache coherent masters it is scalable. The cache coherence manager sends Snooped Data to original requester with 4-hop or 3-hop transactions. The cache coherence manager determines which responding cache coherence master IP core supplies data to requesting cache coherence master IP core; request other cache coherence master IP cores which could provide data to drop data. The cache coherence manager requests data from memory target IP core when no cache coherence master IP core has data to supply. The cache coherence manager updates to memory and downstream caches, if necessary. CM Takes on responsibility in some cases when requesting master is not sophisticated —, for example, see the discussion on “Indirect Writeback Flag” herein. The cache coherence manager Takes on responsibility to send cache maintenance transactions to downstream cache(s). The cache coherence manager Supports speculative memory accesses. The logic handles all virtual memory related broadcast and gather operations since the functionality required is similar to snoop broadcast and collection logic also implemented here. The cache coherence manager resolves conflicts/races and determine ordering between transactions of coherent requests. The logic puts serializes write requests to coherent space (i.e., write-write, read-write, or write-read access sequence to the same cache line). Write back transactions, which are also writes, treated differently since they do not generate snoops. Thus, the serialization point is the logic in coherence manager that orders or serializes conflicting requests. The cache coherence manager ensures conflicting transactions are chained in strict order at coherence manager and this order seen by all coherence masters in that domain. The cache coherence manager prevents protocol deadlocks by ensuring strict hierarchy for coherent transaction completion. The cache coherence manager may sequence snoopable requests from master→snoops from coherence manager→non-snoopable requests from master (A→B means completion of A depends on completion of B). The cache coherence manager assumes it gets NO help from CCMs for conflict resolution—it infers all conflicts and resolves them.

The logic in the cache coherence manager may also perform ordering of transactions between sender-receiver pair on a protocol channel within the interconnect and maintain “per-address” (or per cache line) FIFO ordering.

The Coherence Manager architecture can also include storage hardware. Storage options for the snoop, snoop-filter and/or directory Coherence Managers may be as follows. They can use compiled memory available from standard TSMC libraries—basically SRAM with additional control for read/write ports. In an embodiment, the architectural structure contains a CAM memory structure which can handle multiple transactions—those that are to distinct cache lines and those to the same cache line. Multiple transactions to the same cache line are placed on a conflict chain. The conflict chain is normally kept sorted by the order of arrival (exception is write back and write clean transactions—these need to make forward progress to handle the snoop [symbol] WB/WC interaction—this part is).

Each transaction entry in the CAM has a number of fields. Apart from the usual ones (e.g., transaction id), the following fields are defined as follow.

Speculation flag: whether memory speculation is enabled for this transaction or not. Note that this not only depends on the parameter setting for the cache coherence master IP core from where this transaction was generated but also on the current state of the overall system (is traffic to DRAM channel so high that it is not worthwhile to send speculative requests—this assumes that Sonics IP is monitoring the traffic to DRAM channel).

Snoop count: Number of outstanding snoop responses—prior to a broadcast snoop, this field is initialized to the number of snoop requests to be sent out (depends on shareability domain). As each snoop response is received, this counter is decremented. A necessary condition for transaction deallocation is this counter going to zero.

Indirect Writeback Flag: This flag is initially reset. It is set when a responding Snoop Agent also needs to update the memory target IP core because the responding cache coherence master IP core gives up ownership of the line and the requesting cache coherence master IP core does not accept ownership of the line. In this case, the Snoop Agent indicates to the CM, through its snoop response that it will be updating the memory target IP core—it is proposed that the completion response from the memory target IP core be sent to the CM. As soon as this snoop response is received, the Indirect Writeback flag is set. When the response from the memory target IP core is received, this flag is reset.

The coherence manager may have its intelligence distributed 1) within the interconnect as shown in FIGS. 1 and 2 or 2) within the memory controller as shown in FIG. 3, or 3) any combination of both. Thus, the cache coherence manager may be geographically distributed amongst many locations downstream of the target agent in a memory controller. The pluggable-in cache coherence manager has a wider ability to cross clock domain boundaries.

The plug in cache coherence manager, coherence logic in agents, and split interconnect design allows for scalability that uses of a common flexible architecture to implement a wide range of Systems on a Chip that feature a variety of cache coherent masters and un-cached masters while optimizing performance and area. The design also allows a partitioning strategy that allows other Intellectual Property blocks to be mixed and matched with both the coherent and non-coherent IP blocks. Thus the SoC has 1) two or more cache coherent master/initiators that each maintains its own coherent caches and 2) one or more un-cached master/initiators that issue communication transactions into coherent and non-coherent address spaces. For example, UCMs and NCMs can also be connected to the interconnect that handles cache coherence master IP cores. FIG. 1, for example, also shows the CCMs, UCMs, and NCMs being connected to the interconnect that handles the coherent traffic.

Cache Coherence may be defined as a cache coherent system requires the following two conditions to be satisfied:

A write must eventually be made visible to all master entities—accomplished in invalidate protocols by ensuring that a write is considered complete only after all the cached copies other than the one which is updated are invalidated

Writes to the same location must appear to be seen in the same order by all masters.

Two conditions which ensure this are:
i. Writes to the same location by multiple masters are serialized, i.e., all masters see such writes in the same order—accomplished by requiring that all invalidate operations for a location arise from a single point in the coherent controller and that the interconnect preserves the ordering of messages between two entities.
ii. A read following a write to the same memory location is returned only after the write has completed.

In an embodiment, Masters/initiator intellectual property cores maybe classified as “coherent” and “non-coherent”. Coherent masters, which are capable of issuing coherent transactions, are further classified as Cached Coherent Masters and Un-cached Coherent Masters.

A cache coherence master IP core has a coherent cache associate with that master (from a system perspective because internally within a given master intellectual property core there may be many local caches but from a system perspective there is at least one in that master/initiator intellectual property core) and, in the context of an protocol, such as AXI4, is capable of issuing the full set of transactions, such as ACE transactions. A coherent Master IP core generally maintains its own coherent caches. Coherent transactions have communication transactions with intended destinations to shareable address space while non-coherent transactions target non-shareable address space. The cache coherence master IP core requires an additional snoop port and snoop target agent with its coherence logic added to the interconnect interface boundary.

An Un-cached Coherent Master (UCM) does not maintain a coherent cache on its own if it has one and, in the context of AXI4, is capable of issuing merely a subset of the coherent transactions. An un-cached Coherent Master may issue transactions into coherent and non-coherent address spaces. Note, that an UCM may have a cache which is not kept coherent. Coherent transactions target shareable address space while non-coherent transactions target non-shareable address space.

A Non-Coherent Master (NCM) issues only non-coherent transactions targeting non-shareable address space. Thus, a non-coherent master only issues transactions into non-coherent address space of IP target cores. In the context of AXI, it is capable of issuing AXI3 or the non-ACE related transactions of AXI4. An NCM does not have a coherent cache but, like a UCM, may have a cache which is not kept coherent.

As discussed briefly above, Agents, including master agents, target agents, and snoop agents, may be configured with intelligent Coherence Control logic surrounding the dataflow fabric and coherence command and signaling fabric. The intelligent logic is configured to control a sequencing of coherent and non-coherent communication transactions while reducing latency for coherent transfer communications. For example, referring to FIG. 1, the coherence logic is located in one or more agents including a regular master agent and a snoop agent for the first cache coherent master intellectual property core. The first cache coherent master intellectual property core has two separate ports, where the regular master agent is on a first port and the snoop agent is on a second port. The snoop agent has the coherence logic configured to handle command and signaling for snoop coherence traffic. The snoop agent port for the first cache coherent master logically tracks and responds to snoop requests and responses, and the regular master agent is configured to handle the data traffic for the first cache coherent master intellectual property core. The intelligent coherence control logic can be located in the agents at the edge boundaries of the interconnect or internally within the interconnect at routers within the interconnect. The intelligence may split communication traffic, such as request traffic, from the Master Agent into the coherent fabric and system request fabrics and the response traffic from the Snoop Agent into the coherent fabric and dataflow response fabric. Two separate ports exist for coherent masters/initiators at the interface between the interconnect and the IP core: a regular agent on a first port; and a snooping agent on a second port.

The Snoop Agent (STA) has coherence logic configured to handle the command and signaling for snoop coherence traffic, where the snoop agent port for that cache coherent master logically tracks and responds to snoop requests and responses. For example, in the context of AXI, it means the agent having all 3 channels. Also, a version may also handle Distributed Virtual Message traffic.

A Snoop Agent port is added for cache coherence master IP core interfacing with the interconnect to handle snoop requests and responses. The Snoop Agent handles requests (with no data) from the coherence fabric. The Snoop Agent interacts with the Coherence Manager—forward snoop response data to requesting cache coherence master IP core or drop snooped data. The Snoop Agent responds to both coherence (snoop response) and non-coherent fabrics (data return to original requester. The Snoop Agent has logic for handling snoop responses.

Two alternatives may be implemented with partitioning: 1) Where the Master Agent sends coherent traffic (commands only) to the coherent fabric or 2) Where the Master Agent sends all requests to the system fabric which in turn routes requests to the coherent fabric. The main advantage of the former is that coherent requests, which are typically latency sensitive, have lower latency (both w.r.t number of hops and traffic congestion). The main advantage of the latter is the relative simplicity in the Master Agent—the FIP continues to be a 1-in, 1-out component while in the former, the FIP has to be enhanced to do routing also (1-in, 2-out).

As discussed briefly above referring to FIG. 1, structurally, the interconnect is composed of two separate fabrics configured to cooperate with each other: 1) a data flow bus fabric separate from 2) its coherence command and signaling fabric that couples to a flexible implementation of a cache coherence manager. The coherence command and signaling fabric is configured to convey signaling and commands to maintain the system cache coherence scheme. The data flow bus fabric is configured to carry non-coherent traffic and all data traffic transfers between the three or more master intellectual property cores and the IP target memory core in the System on a Chip 100. Thus, the coherence command and signaling fabric carries the non-data part of the coherent traffic—i.e., coherent command requests (without data), snoop requests, snoop responses (without data). The data flow bus fabric carries non-coherent traffic and all the data traffic. The coherence command and signaling fabric and the data flow bus fabric communicate through an internal protocol.

FIG. 6 illustrates a diagram of an embodiment of an Organization of a Snoop Filter based cache coherent manager. Each instance of snoop-filter based cache coherence manager 602 may have a set amount of storage entries organized as a SRAM buffer, a CAM structure, or other storage structure. Each snoop-filter storage entry may have the following fields: a tag id which is a subset of the physical address, a Presence Vector (PV), an Owned Vector (OV), and an optional replacement hints (RH) state.

There may be 1 presence bit per cache coherent master IP core or group of cache coherent master IP cores. The presence vector has a flat organization with bit[i] indicating if Cache Coherence Master_i has the cache line of interest, represented by the tagid, in a valid state (UD, SD, UC, SC states) or not (I state). A flat scheme should suffice since we expect the number of clusters to be cache coherence master IP cores to be 4-8. Typically, such an organization can scale up to 16 cache coherence master IP cores. When the number of cache coherence master IP cores grows large (beyond 16, say), it is expected that multiple interconnects will handle coherence. The presence vector would then have an additional bit for each interconnect which would indicate the presence of the cache line among one of the cache coherence master IP cores managed by the other interconnect. This hierarchical organization is not discussed in this specification since such an architecture is still at the concept level.

The owned vector may have encodings to indicate statuses such as dirty, unused, owned, etc.

Thus, the snoop-filter based cache coherence manager 602 may use a flat scheme with a presence vector with one bit per CCM and an owned bit for UD/SD lines.

In an embodiment, the snoop-filter based cache coherence manager uses a set associative CAM organization for good tradeoff between timing/area/cost. The set associativity, k and the total number of SF entries are user configurable.

The snoop-filter based cache coherence manager 602 may use logic architecture built assuming back invalidations and use ACE cache maintenance transactions to invalidate capacity/conflict lines in CCM cache.

The snoop-filter based cache coherence manager 602 has user configurable organization including a: 1) a directory height (number of storage entries) and associativity, which is a tradeoff between snoop-filter occupying area and/or timing added into processing of coherent communications verses minimizing back invalidations. The snoop-filter based cache coherence manager may use precise “evict” information and appropriate sizing of snoop filter, back invalidations of potentially useful lines in CCM caches can be eliminated.

The snoop-filter based cache coherence manager 602 assists with partitioning the system. The snoop-filter can be organized so that an access to it almost never results in a capacity or conflict miss. Assume, for ease of exposition, that each cache coherence master IP core has an inclusive cache hierarchy with a highest level cache (say, L2) and that the cache organization of L2 is the same across all cache coherence master IP cores (c-way set associative, number of sets=s). Let the number of cache coherence master IP cores be n. If the snoop-filter is organized with an amount of storage entries of k, where k=n*c and with height (i.e., number of rows)=s then every non-compulsory access to the snoop-filter results in a hit. This means that with this organization, a snoop-filter access will almost never result in a need to invalidate a line in one or more Cache Coherence Masters' L2 because of a capacity or conflict miss in the snoop-filter. An invalidation arising from a capacity or conflict miss in the snoop-filter is called a back invalidation.

Note, building a central or distributed snoop-filter based cache coherence manager that do not result in back invalidations is expensive both in area (logic gates) and timing (high associativity) but result in higher performance since cache lines in L2 do not need to be invalidated (invalidation costs are the invalidation latency and more important that a replaced line in L2 will be needed by a cache coherence master IP core in the future). The snoop-filter organization will allow both the height (# of sets) and the width (associativity) to be configurable by the user to tailor their coherence scheme for appropriate performance-area-timing tradeoffs. The user can be guided in selection of storage entries with an example measure for the effectiveness of snoop-filters with the coverage ratio defined below.

$$SF Coverage Ratio = \frac{\# SF storage entries}{\# L 2 cache lines + \# of CCMS}$$

where the # snoop-filter storage entries=number of entries in the snoop-filter (i.e., k*#rows see figure X), and the #L2 cache lines=c (set-associativity)*#sets in each cache coherence master IP core, and the #Cache Coherence Masters=number of cache coherence master IP cores.

The Snoop Filter (SF) Actions may include the following.

A snoop-filter based cache coherence manager lookup 602 in its storage entry is performed for all request transaction types except those belonging to non-snooping, barrier, and DVM. For the memory update transactions, no snoops are generated; additionally, the Evict transaction does not result in any transaction to memory target IP core but just results in updating the snoop-filter state vectors.

A snoop-filter storage entry lookup results in hit or a miss. First, the transaction flow for each transaction type is described assuming a hit followed by the similar flows when the lookup results in a miss. Note, in the three flow case examples given below, it is assumed that there is a request from a given cache coherence master IP core[i]. Transaction Flows for Hit in the snoop-filter based cache coherence manager 602 may be as follows.

1) Case: Invalidating Request Transaction from Cache Coherence Master[i]:

Invalidating snoop transaction is sent to each Cache Coherence Master[j] whose Presence Vector[j]=1 (j≠1). When only Presence Vector [i]=‘b1, then it means that the line is not present in any of the other caches and so there is no need to snoop other caches.

When the invalidating request transaction also needs a data transfer, there are two meaningful architectural options presented to the user for logic as follows.

The Cache Coherence Master IP cores implement an Evict mechanism and that keeps the snoop-filter based cache coherence manager 602 fairly accurate. The snooping portion sends out “read and invalidate” snoop to a conveniently chosen Cache Coherence Master[j] whose Presence Vector[j]=1. The snooping portion repeats this procedure until there has been a data transfer or all cache coherence master IP cores in the Presence Vector have been snooped. Note that it is very likely that the first Cache Coherence Master snooped will result in a data transfer since the SF is kept fairly accurate. In the highly unlikely case that no Cache Coherence Master IP core returns data, a memory request is made.

After the first data return, the rest of the Cache Coherence Masters that have their Presence Vector bits set to 1 are each sent an invalidating transaction. These snoops are sent concurrently and are not in the transaction latency critical path.

(Note, when Cache Coherence Masters do not implement an Evict mechanism, i.e., they silently drop cache lines in SC or SD), then the snooping mechanism is similar to the case when there is no snoop-filter.

When the invalidating request transaction does not need a data transfer (Cache Coherence Master[i] has the data and is just requesting an invalidation), then invalidating snoops (without data transfer) are sent to Cache Coherence Masters whose Presence Vector [i]=‘b1.

After the snoop response(s) are received with possible data transfer, the SF storage entry is updated: 1) Presence Vector[i]←‘b1, all other bits set to ‘b0; 2) Owned Vector←Unique Dirty (‘b01); and 3) Replacement Hints state updated.

2) Case: Read Shared Transaction from Cache Coherence Master[i] (Note: The Presence Vector[i] has to be ‘b0—use as compliance check): There are two meaningful architectural options presented to the user for logic to follow for transferring the data.

The Cache Coherence Master IP cores implement an Evict mechanism and that keeps the snoop-filter based cache coherence manager 602 fairly accurate. The snooping mechanism sends out “read shared” snoop to a conveniently chosen Cache Coherence Master[j] whose Presence Vector [j]=1. If Cache Coherence Master[j] does not have the data, the snooping mechanism repeats this procedure until there has been a data transfer or all Cache Coherence Masters whose Presence Vector bit position=‘b1 have been snooped. Note that it is very likely that the first Cache Coherence Master snooped will result in a data transfer since the snoop-filter based cache coherence manager is kept fairly accurate. In the highly unlikely case that no Cache Coherence Master returns data, a memory request is made.

Note, when the Cache Coherence Masters do not implement an Evict mechanism, i.e., they silently drop cache lines in SC or SD), then the snooping mechanism is similar to the case when there is no snoop-filter.

After the snoop response(s) are received with possible data transfer, the SF entry is updated: 1) The Presence Vector[i]←‘b1/*note: snoop response(s) may result in the Presence Vector being updated since the SF gets the latest updated value from a snooped Cache Coherence Master; 2a) Owned Vector←Shared Dirty (‘b11) if previous Owned Vector state was Unique Dirty or Shared Dirty, and 2b) if←Not Owned (‘b00) if previous Owned Vector state was Not Owned; 3) Replacement Hints state updated.

3) Case: WriteBack/WriteClean/Evict Transaction from Cache Coherence Master[i] (Note: for WB/WC, Owned Vector has to be either Shared Dirty or Unique Dirty; if Owned Vector is Unique Dirty then the Presence Vector has to be one hot else the Presence Vector has at least element of its vector set to ‘b1, for Evict, if the Presence Vector is one hot (i.e., PV[i]=‘b1) then Owned Vector≠Not Owned.

Use above conditions for protocol checks): 1) The Presence Vector[i]←‘b0; Owned Vector←Not Owned if WB and Owned Vector=Unique Dirty or Shared Dirty, 2) Owned Vector←Not Owned if WC, and 3) The Presence Vector [i]←‘b0 if Evict.

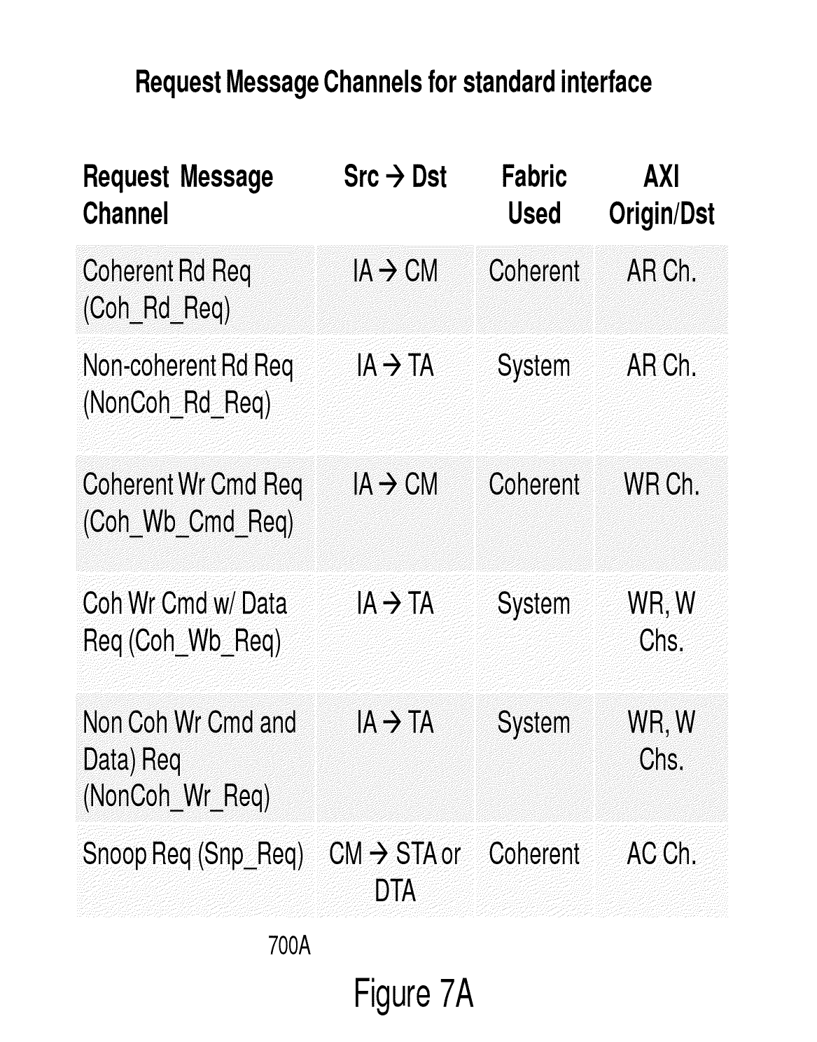

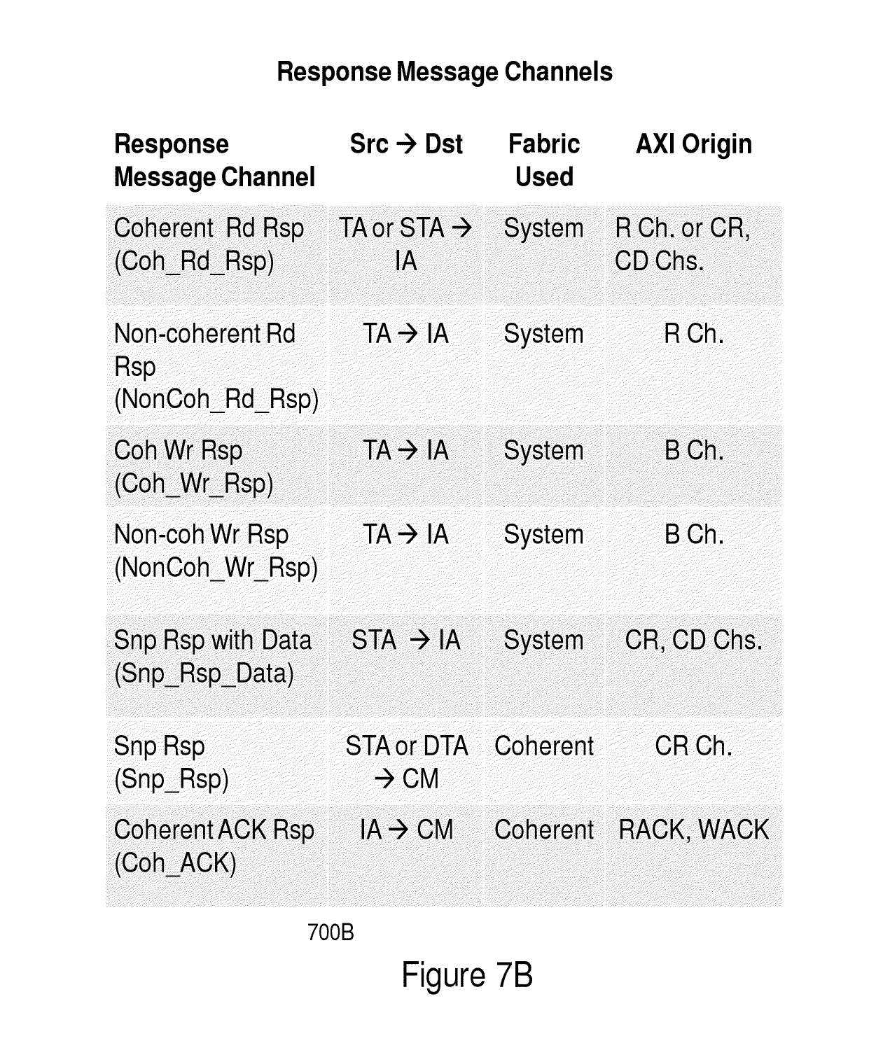

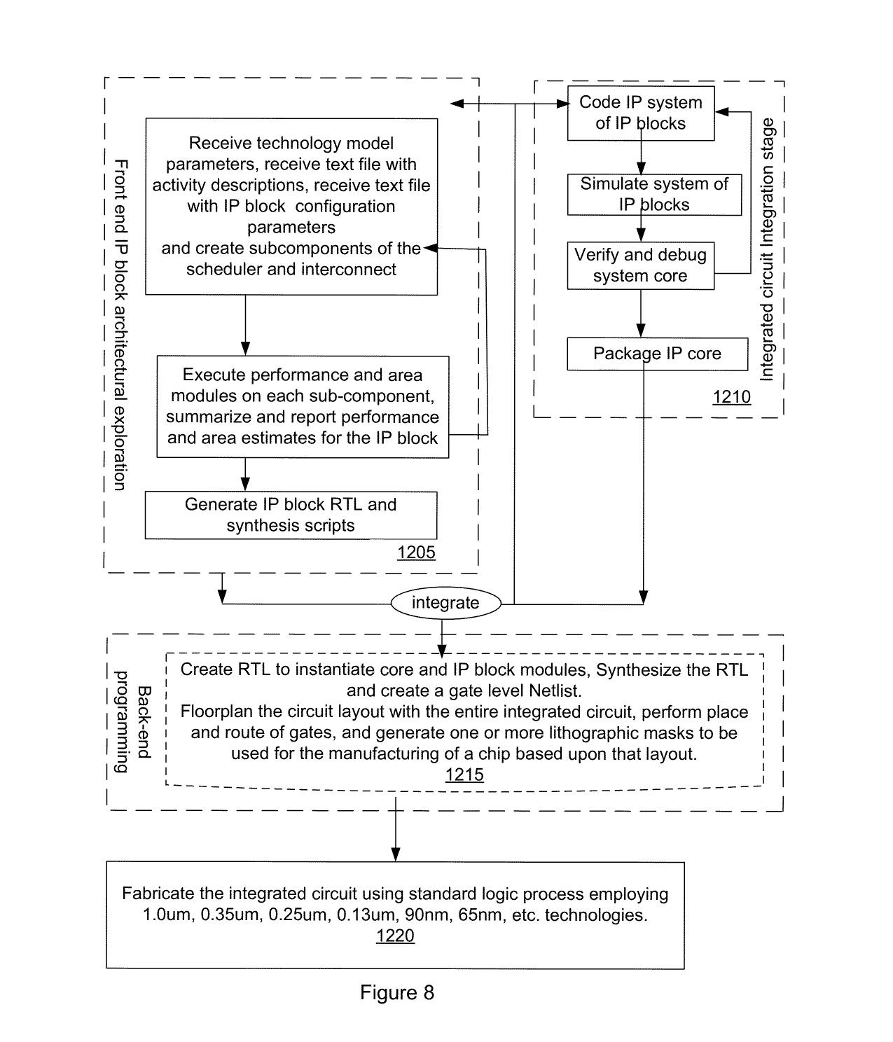

FIGS. 7A and 7B illustrate tables with an example internal transaction flow for the standard interface to support either a directory-based cache coherence manager, a snoop-based cache coherence manager, and a snoop-filter-based cache coherence manager.

FIG. 7A shows an example table 700A listing all the request message channels and the relevant details associated with each channel. Message channels are then mapped to the appropriate “carriers” in a product architecture—virtual channels in a PL based implementation, for example. Note this mapping may be one-to-one (high performance) or many-to-one (for area efficiency). Separate Read Requests into separate message channels mainly because they are headed to different agents (TA, CM). Separate Coherent Write backs into command only (headed to the coherence manager) and command with Data which uses regular network. Add additional message channel for non-coherent writes (which uses regular network).

FIG. 7B shows an example table 700B listing all the response message channels and the relevant details associated with each channel. The standard interface combines traffic from different message classes. Messages from the Coh_ACK class must not be combined with messages from any other message class. This avoids deadlock/starvation. When implemented with VCs, this means Coh_ACK message class must have a dedicated virtual channel for traversing the Master Agent to Coherence Manager path. The standard interface may have RACKs and WACKs on separate channels, which needs fast track to CM for transaction deallocation, minimizing “conflict times”, and also doesn't need an address lookup.

Messages from Coh_Rd, Coh_Wb, NonCoh_Rd, and NonCoh_Wr may all be combined (i.e., traverse on one or more virtual channels without causing protocol deadlocks). Since the Master Agent to Coherence Manager (uses coherence fabric) and the Master Agent to TA (uses system fabric) paths are disjoint, the standard interface separates the coherence and non-coherence request traffic into separate virtual channels. The standard interface may have separate channels for snoop response and snoop response with data mainly because they are headed to different agents (IA, STA).

The system cache coherence support functionally provides many advantages. Transactions in some interconnects have a relatively simple flow—a request is directed to a single target and gets the response from that target. With cache coherence, such a simple flow does not suffice. This document shows detailed examples of relatively sophisticated transaction flows and how the flow changes dynamically based on the availability of data in a particular cached master. There are many advantages in how these transaction flows are sequenced to optimize multiple parameters—for e.g., latency, bandwidth, power, implementation and verification complexity.

In general, in an interconnection network, there are a number of heterogeneous initiator agents (lAs) and target agents (TAs) and routers. As the packets travel from the IAs to the TAs in a request network, their width may be adjusted by operations referred to as link width conversion. The operations may examine individual subfields which may cause timing delay and may require complex logic.

The design may be used in smart phones, servers, cell phone tower, routers, and other such electronic equipment. The plug-in cache coherence manager, coherence logic in the agents, and split interconnect design keeps the “coherence” and “non-coherence” parts of interconnect largely interfaced but physically decoupled. This helps independent optimization, development, and validation of all these parts.

### Simulation and Modeling

FIG. 8 illustrates a flow diagram of an embodiment of an example of a process for generating a device, such as a System on a Chip, in accordance with the systems and methods described herein. The example process for generating a device with designs of the Interconnect and Memory Scheduler may utilize an electronic circuit design generator, such as a System on a Chip compiler, to form part of an Electronic Design Automation (EDA) toolset. Hardware logic, coded software, and a combination of both may be used to implement the following design process steps using an embodiment of the EDA toolset. The EDA toolset such may be a single tool or a compilation of two or more discrete tools. The information representing the apparatuses and/or methods for the circuitry in the Interconnect, Memory Scheduler, etc. may be contained in an Instance such as in a cell library, soft instructions in an electronic circuit design generator, or similar machine-readable storage medium storing this information. The information representing the apparatuses and/or methods stored on the machine-readable storage medium may be used in the process of creating the apparatuses, or model representations of the apparatuses such as simulations and lithographic masks, and/or methods described herein.

Aspects of the above design may be part of a software library containing a set of designs for components making up the scheduler and Interconnect and associated parts. The library cells are developed in accordance with industry standards. The library of files containing design elements may be a stand-alone program by itself as well as part of the EDA toolset.

The EDA toolset may be used for making a highly configurable, scalable System-On-a-Chip (SOC) inter block communication system that integrally manages input and output data, control, debug and test flows, as well as other functions. In an embodiment, an example EDA toolset may comprise the following: a graphic user interface; a common set of processing elements; and a library of files containing design elements such as circuits, control logic, and cell arrays that define the EDA tool set. The EDA toolset may be one or more software programs comprised of multiple algorithms and designs for the purpose of generating a circuit design, testing the design, and/or placing the layout of the design in a space available on a target chip. The EDA toolset may include object code in a set of executable software programs. The set of application-specific algorithms and interfaces of the EDA toolset may be used by system integrated circuit (IC) integrators to rapidly create an individual IP core or an entire System of IP cores for a specific application. The EDA toolset provides timing diagrams, power and area aspects of each component and simulates with models coded to represent the components in order to run actual operation and configuration simulations. The EDA toolset may generate a Netlist and a layout targeted to fit in the space available on a target chip. The EDA toolset may also store the data representing the interconnect and logic circuitry on a machine-readable storage medium. The machine-readable medium may have data and instructions stored thereon, which, when executed by a machine, cause the machine to generate a representation of the physical components described above. This machine-readable medium stores an Electronic Design Automation (EDA) toolset used in a System-on-a-Chip design process, and the tools have the data and instructions to generate the representation of these components to instantiate, verify, simulate, and do other functions for this design. A non-transitory computer readable storage medium contains instructions, which when executed by a machine, then the instructions are configured to cause the machine to generate a software representation of the apparatus.

Generally, the EDA toolset is used in two major stages of SOC design: front-end processing and back-end programming. The EDA toolset can include one or more of a RTL generator, logic synthesis scripts, a full verification testbench, and SystemC models.

Front-end processing includes the design and architecture stages, which includes design of the SOC schematic. The front-end processing may include connecting models, configuration of the design, simulating, testing, and tuning of the design during the architectural exploration. The design is typically simulated and tested. Front-end processing traditionally includes simulation of the circuits within the SOC and verification that they should work correctly. The tested and verified components then may be stored as part of a stand-alone library or part of the IP blocks on a chip. The front-end views support documentation, simulation, debugging, and testing.

In block 1305, the EDA tool set may receive a user-supplied text file having data describing configuration parameters and a design for at least part of a tag logic configured to concurrently perform per-thread and per-tag memory access scheduling within a thread and across multiple threads. The data may include one or more configuration parameters for that IP block. The IP block description may be an overall functionality of that IP block such as an Interconnect, memory scheduler, etc. The configuration parameters for the Interconnect IP block and scheduler may include parameters as described previously.

The EDA tool set receives user-supplied implementation technology parameters such as the manufacturing process to implement component level fabrication of that IP block, an estimation of the size occupied by a cell in that technology, an operating voltage of the component level logic implemented in that technology, an average gate delay for standard cells in that technology, etc. The technology parameters describe an abstraction of the intended implementation technology. The user-supplied technology parameters may be a textual description or merely a value submitted in response to a known range of possibilities.

The EDA tool set may partition the IP block design by creating an abstract executable representation for each IP sub component making up the IP block design. The abstract executable representation models TAP characteristics for each IP sub component and mimics characteristics similar to those of the actual IP block design. A model may focus on one or more behavioral characteristics of that IP block. The EDA tool set executes models of parts or all of the IP block design. The EDA tool set summarizes and reports the results of the modeled behavioral characteristics of that IP block. The EDA tool set also may analyze an application's performance and allows the user to supply a new configuration of the IP block design or a functional description with new technology parameters. After the user is satisfied with the performance results of one of the iterations of the supplied configuration of the IP design parameters and the technology parameters run, the user may settle on the eventual IP core design with its associated technology parameters.

The EDA tool set integrates the results from the abstract executable representations with potentially additional information to generate the synthesis scripts for the IP block. The EDA tool set may supply the synthesis scripts to establish various performance and area goals for the IP block after the result of the overall performance and area estimates are presented to the user.

The EDA tool set may also generate an RTL file of that IP block design for logic synthesis based on the user supplied configuration parameters and implementation technology parameters. As discussed, the RTL file may be a high-level hardware description describing electronic circuits with a collection of registers, Boolean equations, control logic such as “if-then-else” statements, and complex event sequences.

In block 1310, a separate design path in an ASIC or SOC chip design is called the integration stage. The integration of the system of IP blocks may occur in parallel with the generation of the RTL file of the IP block and synthesis scripts for that IP block.

The EDA toolset may provide designs of circuits and logic gates to simulate and verify the operation of the design works correctly. The system designer codes the system of IP blocks to work together. The EDA tool set generates simulations of representations of the circuits described above that can be functionally tested, timing tested, debugged and validated. The EDA tool set simulates the system of IP block's behavior. The system designer verifies and debugs the system of IP blocks' behavior. The EDA tool set tool packages the IP core. A machine-readable storage medium may also store instructions for a test generation program to generate instructions for an external tester and the interconnect to run the test sequences for the tests described herein. One of ordinary skill in the art of electronic design automation knows that a design engineer creates and uses different representations, such as software coded models, to help generating tangible useful information and/or results. Many of these representations can be high-level (abstracted and with less details) or top-down views and can be used to help optimize an electronic design starting from the system level. In addition, a design process usually can be divided into phases and at the end of each phase, a tailor-made representation to the phase is usually generated as output and used as input by the next phase. Skilled engineers can make use of these representations and apply heuristic algorithms to improve the quality of the final results coming out of the final phase. These representations allow the electric design automation world to design circuits, test and verify circuits, derive lithographic mask from Netlists of circuit and other similar useful results.

In block 1315, next, system integration may occur in the integrated circuit design process. Back-end programming generally includes programming of the physical layout of the SOC such as placing and routing, or floor planning, of the circuit elements on the chip layout, as well as the routing of all metal lines between components. The back-end files, such as a layout, physical Library Exchange Format (LEF), etc. are generated for layout and fabrication.

The generated device layout may be integrated with the rest of the layout for the chip. A logic synthesis tool receives synthesis scripts for the IP core and the RTL design file of the IP cores. The logic synthesis tool also receives characteristics of logic gates used in the design from a cell library. RTL code may be generated to instantiate the SOC containing the system of IP blocks. The system of IP blocks with the fixed RTL and synthesis scripts may be simulated and verified. Synthesizing of the design with Register Transfer Level (RTL) may occur. The logic synthesis tool synthesizes the RTL design to create a gate level Netlist circuit design (i.e. a description of the individual transistors and logic gates making up all of the IP sub component blocks). The design may be outputted into a Netlist of one or more hardware design languages (HDL) such as Verilog, VHDL (Very-High-Speed Integrated Circuit Hardware Description Language) or SPICE (Simulation Program for Integrated Circuit Emphasis). A Netlist can also describe the connectivity of an electronic design such as the components included in the design, the attributes of each component and the interconnectivity amongst the components. The EDA tool set facilitates floor planning of components including adding of constraints for component placement in the space available on the chip such as XY coordinates on the chip, and routes metal connections for those components. The EDA tool set provides the information for lithographic masks to be generated from this representation of the IP core to transfer the circuit design onto a chip during manufacture, or other similar useful derivations of the circuits described above. Accordingly, back-end programming may further include the physical verification of the layout to verify that it is physically manufacturable and the resulting SOC will not have any function-preventing physical defects.

In block 1320, a fabrication facility may fabricate one or more chips with the signal generation circuit utilizing the lithographic masks generated from the EDA tool set's circuit design and layout. Fabrication facilities may use a standard CMOS logic process having minimum line widths such as 1.0 um, 0.50 um, 0.35 um, 0.25 um, 0.18 um, 0.13 um, 0.10 um, 90 nm, 65 nm or less, to fabricate the chips. The size of the CMOS logic process employed typically defines the smallest minimum lithographic dimension that can be fabricated on the chip using the lithographic masks, which in turn, determines minimum component size. According to one embodiment, light including X-rays and extreme ultraviolet radiation may pass through these lithographic masks onto the chip to transfer the circuit design and layout for the test circuit onto the chip itself.

The EDA toolset may have configuration dialog plug-ins for the graphical user interface. The EDA toolset may have an RTL generator plug-in for the SocComp. The EDA toolset may have a SystemC generator plug-in for the SocComp. The EDA toolset may perform unit-level verification on components that can be included in RTL simulation. The EDA toolset may have a test validation testbench generator. The EDA toolset may have a dis-assembler for virtual and hardware debug port trace files. The EDA toolset may be compliant with open core protocol standards. The EDA toolset may have Transactor models, Bundle protocol checkers, OCPDis2 to display socket activity, OCPPerf2 to analyze performance of a bundle, as well as other similar programs.

As discussed, an EDA tool set may be implemented in software as a set of data and instructions, such as an instance in a software library callable to other programs or an EDA tool set consisting of an executable program with the software cell library in one program, stored on a machine-readable medium. A machine-readable storage medium may include any mechanism that stores information in a form readable by a machine (e.g., a computer). For example, a machine-readable medium may include, but is not limited to: read only memory (ROM); random access memory (RAM); magnetic disk storage media; optical storage media; flash memory devices; DVD's; EPROMs; EEPROMs; FLASH, magnetic or optical cards; or any other type of media suitable for storing electronic instructions for more than a transient period of time. The instructions and operations also may be practiced in distributed computing environments where the machine-readable media is stored on and/or executed by more than one computer system. In addition, the information transferred between computer systems may either be pulled or pushed across the communication media connecting the computer systems.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. For example, the encoding and decoding of the messages to and from the CDF may be performed in hardware, software or a combination of both hardware and software. It has proven convenient at times, principally for reasons of common usage, to refer to these signals as bits, values, elements, symbols, characters, terms, numbers, or the like.

While some specific embodiments of the invention have been shown, the invention is not to be limited to these embodiments. The invention is to be understood as not limited by the specific embodiments described herein, but only by scope of the appended claims.

1. An apparatus, comprising:
a plug-in cache coherence manager, coherence logic in one or more agents, and an interconnect for a System on a Chip are configured to provide a scalable cache coherence scheme for the System on a Chip that scales to an amount of cache coherent master intellectual property cores in the System on a Chip, where the plug-in cache coherence manager and coherence logic maintain consistency of memory data stored in one or more local memory caches including a first local memory cache for a first cache coherent master intellectual property core and a second local memory cache for a second cache-coherent master intellectual property core, where two or more master intellectual property cores including the first and second intellectual property cores are configured to send read or write communication transactions over the interconnect to an IP target memory core, as well as a third intellectual property core in the System on a Chip that is a non-cache-coherent master intellectual property core, which is also configured send read or write communication transactions over the interconnect to the IP target memory core.

2. The apparatus of claim 1, wherein the interconnect is composed of 1) a data flow bus fabric separate from 2) its coherence command and signaling fabric that couples to a flexible implementation of a cache coherence manager, where the coherence command and signaling fabric is configured to convey signaling and commands to maintain the system cache coherence scheme and where the data flow bus fabric is configured to carry non-coherent traffic and all data traffic transfers between the three or more master intellectual property cores and the IP target memory core in the System on a Chip.

3. The apparatus of claim 1, wherein the plug-in cache coherence manager is implemented as any of one of the following 1) a snooping-based cache coherence manager, 2) a snoop-filtering-based cache coherence manager and 3) a distributed directory-based cache coherence manager, where a logic block for the cache coherence manager can plug in a variety of hardware components in the logic block to support one of the three system coherence schemes above without changing the interconnect and the coherence logic in the agents.

4. The apparatus of claim 3, wherein the plug-in cache coherence manager supports any of the three system coherence schemes via a standard interface at a boundary between the coherence command and signaling fabric and the logic block of the cache coherence manager, wherein the standard interface allows different forms of logic to be plugged into the logic block of the cache coherence manager to enable supporting the variety of system coherence schemes.

5. The apparatus of claim 3, wherein the plug-in cache coherence manager is implemented as a snoop-based cache coherence manager that cooperates with the coherence logic to broadcast a cache access of the first local memory cache to all other local memory caches, and vice versa, for the cache coherent master IP cores in the System on a Chip, where the snoop-based cache coherence manager relies on a snoop broadcast scheme for snooping, and supports both the cache coherent master IP cores and any un-cached coherent master IP cores.

6. The apparatus of claim 3, wherein the plug-in cache coherence manager is implemented as a single snoop filter-based cache coherence manager that cooperates with the coherence logic to manager individual caches for access to memory locations that they have cached, where the snoop-filter reduces the snooping traffic by maintaining a plurality of entries, each entry representing a cache line that is owned by one or more nodes, where the cache coherence master IP cores communicate through a coherence command and signaling fabric with the single snoop filter-based cache coherence manager, where the snoop filter-based cache coherence manager performs a table look up on the plurality of entries to determine a status of cache line entries in all of the local cache memories as well as periodic snooping to check on a state on cache coherent data in each local cache.

7. The apparatus of claim 3, wherein the plug-in cache coherence manager is implemented as a directory-based cache coherence manager that keeps track of data being shared in common directory that maintains coherence between at least the first and second local memory caches, where when an entry is changed in the common directory, the directory either updates or invalidates the other local memory caches with that entry, where the directory performs a table look up to check on the state on cache coherent data in each local cache, and the directory-based cache coherence manager is composed of two or more instances of directory that communicate with each other via a coherence command and signaling fabric.

8. The apparatus of claim 1, wherein the plug-in cache coherence manager has hop logic configured to implement either a 3-hop or a 4-hop protocol, where in the 4-hop protocol, a snooped cache line state is first sent to the cache coherent manager and then the coherent manager is responsible for arranging a sending of data to a requesting cache coherent master IP core, and where the 3-hop protocol supports a direct ‘cache-to-cache’ transfer, and where the cache coherence manager has also has ordering logic to configured to order cache accesses between the two or more masters IP cores in the System on a Chip.

9. The apparatus of claim 1, wherein the plug-in cache coherence manager has logic configured 1) to handle all coherence of cache data requests from the cache coherent masters and un-cache coherent masters, 2) to order cache accesses between the two or more masters IP cores in the System on a Chip, 3) to resolve conflicts between the two or more masters IP cores in the System on a Chip, 4) to generate snoop broadcasts and perform a table lookup, and 5) to support for speculative memory accesses.

10. The apparatus of claim 2, wherein the coherence logic in one or more agents surrounds the dataflow fabric and the coherence command and signaling fabric, where the coherence logic is configured to control a sequencing of coherent and non-coherent communication transactions while reducing latency for coherent transfer communications.

11. The apparatus of claim 2, wherein the coherence logic is located in one or more agents including a regular master agent and a snoop agent for the first cache coherent master intellectual property core, where the first cache coherent master intellectual property core has two separate ports where the regular master agent is on a first port and the snoop agent is on a second port, where the snoop agent has the coherence logic configured to handle command and signaling for snoop coherence traffic, where the snoop agent port for the first cache coherent master logically tracks and responds to snoop requests and responses, and the regular master agent is configured to handle the data traffic for the first cache coherent master intellectual property core.

12. A non-transitory computer readable storage medium containing instructions, which when executed by a machine, the instructions are configured to cause the machine to generate a software representation of the apparatus of claim 1.

13. A method of maintaining cache coherence in a System on a chip with both multiple cache coherent master IP cores and uncached coherent master IP cores, comprising:
using a plug-in cache coherence manager, coherence logic in one or more agents, and an interconnect for a System on a Chip to provide a scalable cache coherence scheme for the System on a Chip that scales to an amount of cache coherent master intellectual property cores in the System on a Chip;
communicating over the interconnect with two or more of the master IP cores, which are cache coherent masters that each includes at least one processor operatively coupled through the plug-in cache coherence manager to at least one cache that stores data for that master IP core, where the data from the cache is also stored permanently in a main memory target IP core, where the main memory target IP core is shared among the multiple master IP cores that also includes the un-cached coherent master IP core that shares the main memory target IP core, where the plug-in cache coherence manager maintains cache coherence responsive to a cache miss of a cache line on a first cache of the caches, then broadcasts a request for an instance of the data stored corresponding to cache miss of the cache line in the first cache, where each cache coherent master maintains its own coherent cache and each un-cached coherent master is configured to issue communication transactions into both coherent and non-coherent address spaces.

14. The method of claim 13, wherein the interconnect uses 1) a data flow bus fabric separate from 2) its coherence command and signaling fabric that couples to a flexible implementation of a cache coherence manager, where the coherence command and signaling fabric conveys signaling and commands to maintain the system cache coherence scheme, and where the data flow bus fabric carries non-coherent traffic and all data traffic transfers between the master intellectual property cores and the IP target memory core in the System on a Chip.

15. The method of claim 13, wherein the plug-in cache coherence manager is implemented as any of one of the following 1) a snooping-based cache coherence manager, 2) a snoop-filtering-based cache coherence manager and 3) a distributed directory-based cache coherence manager, where a logic block for the cache coherence manager can plug in a variety of hardware components in the logic block to support one of the three system coherence schemes above without changing the interconnect and the coherence logic in the agents.

16. The method of claim 15, wherein the plug-in cache coherence manager supports any of the three system coherence schemes via a standard interface at a boundary between the coherence command and signaling fabric and the logic block of the cache coherence manager, wherein the standard interface allows different forms of logic to be plugged into the logic block of the cache coherence manager to enable supporting the variety of system coherence schemes.

17. The method of claim 15, wherein the plug-in cache coherence manager is implemented as a snoop-based cache coherence manager that cooperates with the coherence logic to broadcast a cache access of a first local memory cache to all other local memory caches for the cache coherent master IP cores in the System on a Chip, where the snoop-based cache coherence manager relies on a snoop broadcast scheme for snooping, and supports both the cache coherent master IP cores and any un-cached coherent master IP cores.

18. The method of claim 15, wherein the plug-in cache coherence manager is implemented as a single snoop filter-based cache coherence manager that cooperates with the coherence logic to manager individual caches for access to memory locations that they have cached, where the snoop-filter reduces the snooping traffic by maintaining a plurality of entries, each representing a cache line that is owned by one or more nodes, where the cache coherence master IP cores communicate through a coherence command and signaling fabric with the single snoop filter-based cache coherence manager, where the snoop filter-based cache coherence manager performs a table look up on the plurality of entries to determine a status of cache line entries in all of the local cache memories as well as periodic snooping to check on a state on cache coherent data in each local cache.

19. The method of claim 15, wherein the plug-in cache coherence manager has hop logic to implement either a 3-hop or a 4-hop protocol, where in the 4-hop protocol, a snooped cache line state is first sent to the cache coherent manager and then the coherent manager is responsible for arranging a sending of data to a requesting cache coherent master IP core, and where the 3-hop protocol supports a direct ‘cache-to-cache’ transfer, and where the cache coherence manager has also has ordering logic to configured to order cache accesses between the two or more masters IP cores in the System on a Chip.

20. The method of claim 14, wherein the coherence logic is located in one or more agents including a regular master agent and a snoop agent for the first cache coherent master intellectual property core, where the first cache coherent master intellectual property core has two separate ports where the regular master agent is on a first port and the snoop agent is on a second port, where the snoop agent has the coherence logic configured to handle command and signaling for snoop coherence traffic, where the snoop agent port for the first cache coherent master logically tracks and responds to snoop requests and responses, and the regular master agent is configured to handle the data traffic for the first cache coherent master intellectual property core.
